(19) United States
(12) Patent Application Publication
(10) Pub. No.: US 2025/0282409 A1
(43) Pub. Date: Sep. 11, 2025

(54) SENSING DRIVING WHEEL AND METHOD FOR FABRICATING THE SAME

(71) Applicant: PIXART IMAGING INC., HSIN-CHU (TW)

(72) Inventors: YU-SHENG LIN, HSIN-CHU (TW); CHIN-HUA HU, HSIN-CHU (TW); YU-HAN CHEN, HSIN-CHU (TW)

(21) Appl. No.: 18/894,115

(22) Filed: Sep. 24, 2024

(30) Foreign Application Priority Data
Mar. 8, 2024 (TW) 113108489

(51) Int. Cl. B62D 1/06

(52) U.S. Cl. CPC B62D 1/065

(57) ABSTRACT

A sensing steering wheel and a method for fabricating the same are provided. The sensing steering wheel includes a steering wheel grip and a sensing circuit layer. The sensing circuit layer includes an elastic base layer, an elastic sensing pattern layer and a first insulating protective layer. The elastic base layer has a first surface and a second surface opposite to each other. The elastic sensing pattern layer is disposed on the first surface, the elastic sensing pattern layer is formed of a stretchable conductive material and includes at least one sensor unit and at least one sensing line corresponding to the at least one sensor unit. The first insulating protective layer is disposed on the elastic sensing pattern layer. The sensing circuit layer has an enclosed belt structure and is stretched to sleeve onto the steering wheel grip.

### CROSS-REFERENCE TO RELATED PATENT APPLICATION

This application claims the benefit of priority to Taiwan Patent Application No. 113108489, filed on Mar. 8, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a device and a method for fabricating the same, and more particularly to a sensing steering wheel and a method for fabricating the same.

### BACKGROUND OF THE DISCLOSURE

Existing capacitive sensing steering wheels have the capability to gauge and make determinations based on the driver's grip on the steering wheel. Furthermore, conductive fabrics with built-in sensors can be utilized for sensing in such steering wheels, so as to eliminate the need for metal wires, thereby reducing costs. However, given that sensor fabrics constructed from the conductive fabrics lack elasticity, the assembly and manufacturing processes implemented for the steering wheel must be modified in accordance with the shape/structure of these sensor garments, and the complexity of the processes will increase as the number of sensing areas increases.

In addition, in the existing assembly processes for capacitive sensing steering wheels, the sensor fabric is usually attached to a steering wheel pre- coated with an adhesive. Nevertheless, due to the lack of elasticity in the sensor fabric, wrinkles are bound to be formed on the sensor fabric when being affixed to the steering wheel. This necessitates extra trimming processes, thereby increasing the total cost. Moreover, for sensing steering wheels that necessitate heating features, an extra procedure of affixing heating pads needs to be incorporated into the manufacturing process, consequently leading to a further increase in overall costs.

### SUMMARY OF THE DISCLOSURE

In response to the above-referenced technical inadequacies, the present disclosure provides a sensing steering wheel and a method for fabricating the same, which can reduce the complexity of assembly and production and reduce the manufacturing cost.

In order to solve the above-mentioned problems, one of the technical aspects adopted by the present disclosure is to provide a sensing steering wheel, which includes a steering wheel grip and a sensing circuit layer. The sensing circuit layer includes an elastic base layer, an elastic sensing pattern layer and a first insulating protective layer. The elastic base layer has a first surface and a second surface opposite to each other. The elastic sensing pattern layer is disposed on the first surface, the elastic sensing pattern layer is formed of a stretchable conductive material and includes at least one sensor unit and at least one sensing line corresponding to the at least one sensor unit. The first insulating protective layer is disposed on the elastic sensing pattern layer. The sensing circuit layer has an enclosed belt structure and is stretched to sleeve onto the steering wheel grip.

In order to solve the above-mentioned problems, one of the technical aspects adopted by the present disclosure is to provide a method for fabricating a sensing steering wheel, and the method includes: forming an elastic sensing pattern layer with a stretchable conductive material on a first surface of an elastic base layer, in which the elastic sensing pattern layer includes at least one sensing line; forming a first insulating protective layer on the elastic sensing pattern layer, so as to form a sensing circuit layer including the elastic base layer, the elastic sensing pattern layer and the first insulating protective layer, in which the sensing circuit layer has an enclosed belt structure; and stretching the sensing circuit layer and sleeving the sensing circuit onto a steering wheel grip.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic top view of a sensing steering wheel according to a first embodiment of the present disclosure;

FIG. 2 is a partial cross-sectional schematic view of the sensing steering wheel according to the first embodiment of the present disclosure;

FIG. 3 is a schematic cross-sectional view of the sensing circuit layer according to the first embodiment of the present disclosure;

FIG. 4 is a perspective schematic diagram of the sensing circuit layer and the steering wheel grip according to the first embodiment of the present disclosure;

FIG. 5 is a schematic cross-sectional view of the sensing circuit layer according to a second embodiment of the present disclosure;

FIG. 6 is a schematic perspective view of the sensing circuit layer and the steering wheel grip according to the second embodiment of the present disclosure;

FIG. 7 is a flowchart of a method for fabricating a sensing steering wheel according to a third embodiment of the present disclosure;

FIG. 8 is a detailed flowchart of step S72 according to the present disclosure;

FIG. 9 is a schematic diagram showing processes of steps S721 and S722 according to the present disclosure; and

FIG. 10 is a schematic diagram showing a process of step S723 according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

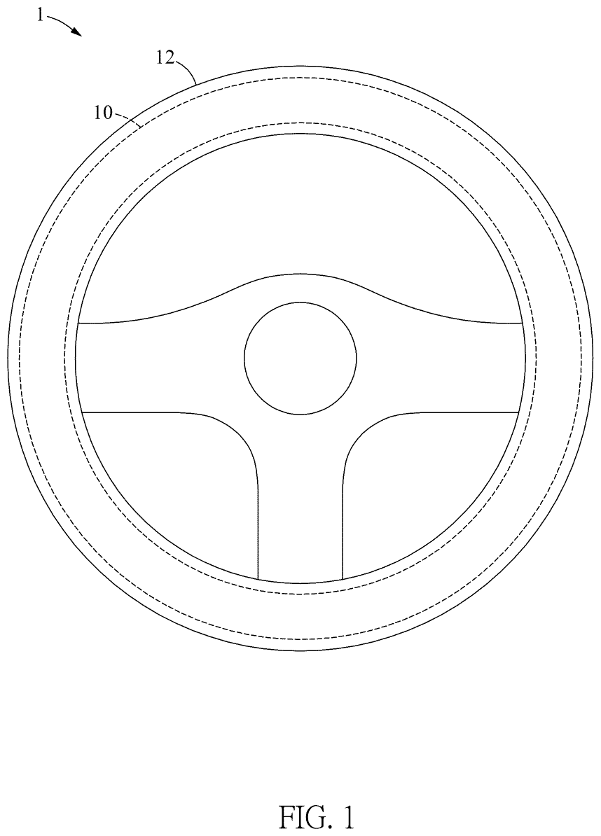

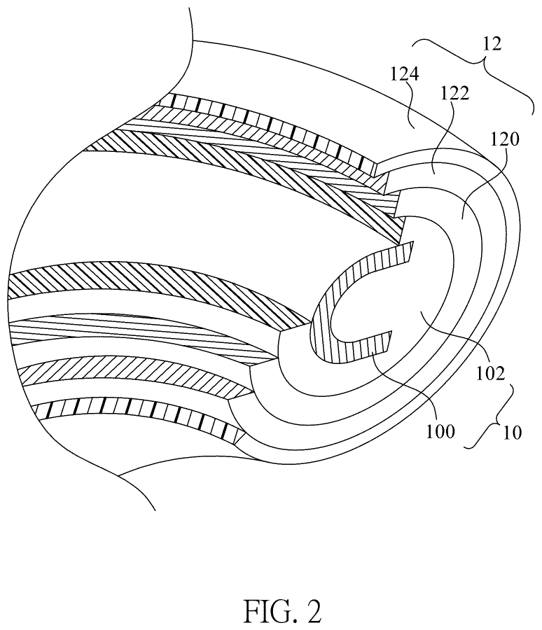

FIG. 1 is a schematic top view of a sensing steering wheel according to a first embodiment of the present disclosure, and FIG. 2 is a partial cross- sectional schematic view of the sensing steering wheel according to the first embodiment of the present disclosure. Referring to FIGS. 1 and 2, the first embodiment of the present disclosure provides a sensing steering wheel 1, which includes a steering wheel grip 10 and a sensing circuit layer 12.

In the embodiment of FIG. 1, the steering wheel grip 10 can be, for example, a steering wheel rim of the sensing steering wheel 1, and can be connected to a hub located in the center of the steering wheel rim through a plurality of spokes. In some embodiments, the hub is coaxially arranged with the steering wheel rim and installed in a vehicle. However, the design of the above-mentioned sensing steering wheel 1 is merely an example, and the present disclosure is not limited thereto.

As shown in FIG. 2, the sensing steering wheel 1 is provided with a steering wheel grip 10 and a sensing circuit layer 12 in an order from the inside to the outside. The steering wheel grip 10 can include a frame 100 and a protective layer 102, and the sensing circuit layer 12 can include an elastic base layer 120, an elastic sensing pattern layer 122 and a first insulating protective layer 124. The frame 100 can be made of hard material such as metal or wood, and the protective layer 102 can include, for example, a leather layer and/or a foam material layer.

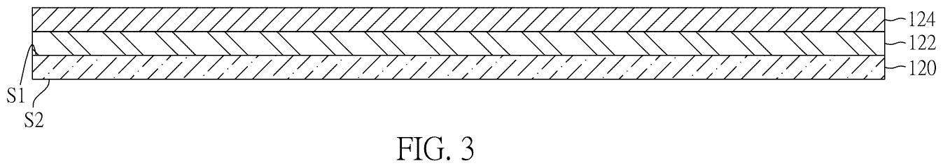

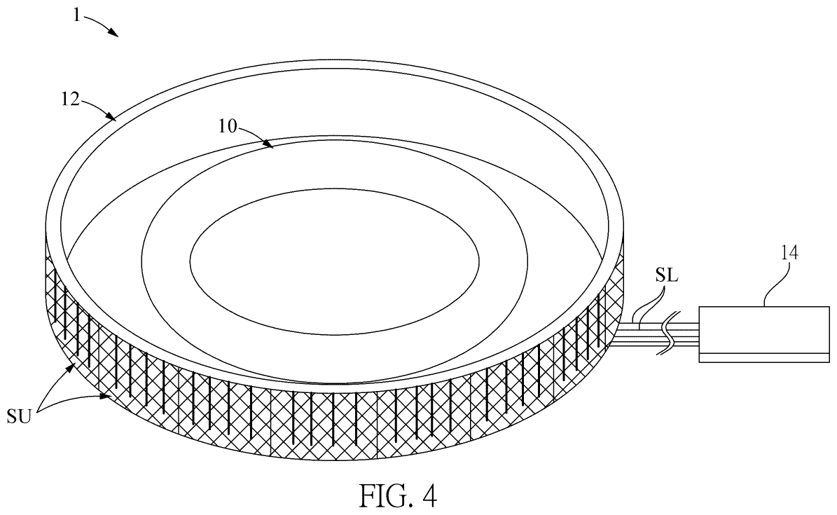

FIG. 3 is a schematic cross-sectional view of the sensing circuit layer according to the first embodiment of the present disclosure, and FIG. 4 is a perspective schematic diagram of the sensing circuit layer and the steering wheel grip according to the first embodiment of the present disclosure. As shown in FIG. 3, for convenience of explanation, the sensing circuit layer 12 is shown as a flat multi-layer structure. The elastic base layer 120 can be made of an elastic base material such as thermoplastic polyurethane (TPU), and has a first surface S1 and a second surface S2 that are opposite to each other.

The elastic sensing pattern layer 122 is disposed on the first surface S1, and the elastic sensing pattern layer 122 is formed of a stretchable conductive material and can include one or more sensor units SU and sensing lines SL corresponding to the sensor units SU as shown in FIG. 4. In some embodiments, the elastic sensing pattern layer 122 can be printed on the first surface S1 of the elastic base layer 120 by printing elastic conductive silver paste or graphene to form the sensor units SU in a single region or multiple regions. The first insulating protective layer 124 is disposed on the elastic sensing pattern layer 122, which can be made of ink, for example, and can provide protection and insulation for the elastic sensing pattern layer 122 to improve the durability thereof. It should be noted that both the elastic base layer 120 and the elastic sensing pattern layer 122 are stretchable and can withstand external force to be capable of being stretched to a certain extent without damaging the sensor units SU and the corresponding sensing lines SL.

It should be noted that in FIG. 4, the sensing circuit layer 12 has an enclosed belt structure, and can be stretched to be larger than a size of the steering wheel grip 10 so as to fit and be sleeved onto the steering wheel grip 10 to form the shape shown in FIGS. 1 and 2. When the sensing circuit layer 12 is sleeved onto the steering wheel grip 10, inner and outer edges of the enclosed belt structure of the sensing circuit layer 12 can be parallel to an annular surface of the steering wheel grip 10. In more detail, circumferential directions of the inner edge and the outer edge of the enclosed belt structure are parallel to a circumferential direction of the annular surface of the steering wheel grip 10. However, it should be noted that the inner and outer edges of a portion of the enclosed belt structure are not necessarily parallel to the annular surface of the steering wheel grip 10, but can be adapted to the spokes of the steering wheel grip 10, such that multiple notches can be formed at the inner and outer edges such that the spokes can be avoided when covering the steering wheel rim.

For convenience of explanation, FIG. 4 shows the sensing circuit layer 12 in a stretched state, and the first insulating protective layer 224 is omitted. Therefore, by utilizing the stretch capability of the elastic base layer 120 (such as TPU), the entire sensing circuit layer 12 can have a better covering effect when covering the steering wheel grip 10 without causing wrinkles. In addition, the thickness of the elastic base layer 120 can be carefully designed to improve the sensing sensitivity and anti-noise interference capability of the sensor units SU and the sensing lines SL.

In this embodiment, the sensing steering wheel 1 further includes a processing circuit 14 electrically connected to the sensing lines SL. The sensor units SU can generate sensing signals in response to the touch of an object (for example, the driver's hand), and the processing circuit 14 can determine a holding state of the steering wheel grip 10 based on the sensing signals.

In some embodiments, the sensing steering wheel 1 can further include a heating layer disposed between the steering wheel grip 10 and the sensing circuit layer 12. The heating layer can be connected to the processing circuit 14 through a plurality of heating lines, and the processing circuit 14 generates heating signals to drive the heating lines to produce thermal energy, thereby providing a heating function for the sensing steering wheel 1 in this embodiment. However, the above examples are only one of the possible embodiments and are not intended to limit the present disclosure.

### Second Embodiment

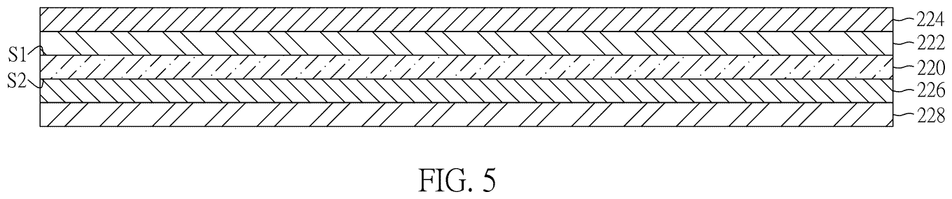

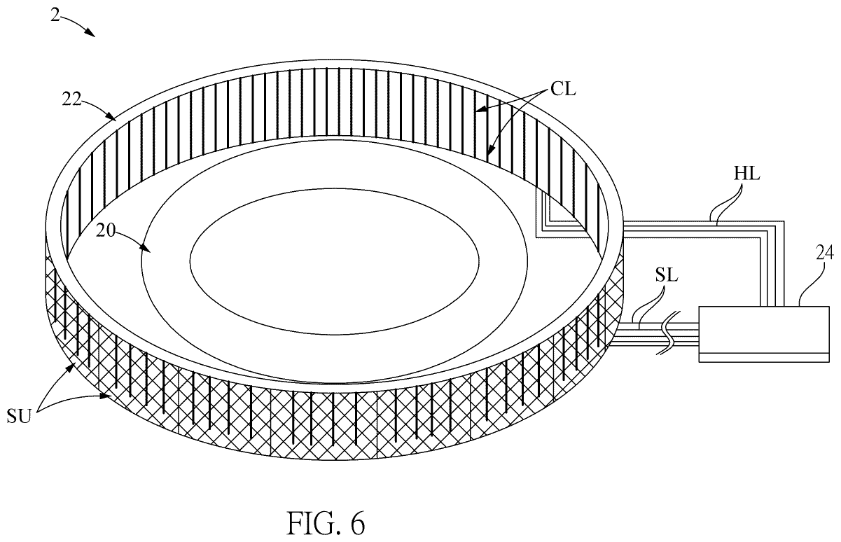

FIG. 5 is a schematic cross-sectional view of the sensing circuit layer according to the second embodiment of the present disclosure, and FIG. 6 is a schematic perspective view of the sensing circuit layer and the steering wheel grip according to the second embodiment of the present disclosure. The second embodiment inherits from the structure of the sensing steering wheel 1 of FIG. 2, and a main difference between the second embodiment and the first embodiment resides in the details of the sensing circuit layer. Referring to FIG. 5, for convenience of explanation, the sensing circuit layer 22 of the second embodiment is shown as a flat multi-layer structure, and the sensing circuit layer 22 includes an elastic base layer 120, an elastic sensing pattern layer 222, and a first insulating protective layer 224, the elastic conductive layer 226 and the second insulating protective layer 228.

Similarly, the elastic base layer 220 can be made of an elastic base material such as thermoplastic polyurethane (TPU), and has a first surface S1 and a second surface S2 that are opposite to each other. The elastic sensing pattern layer 222 is disposed on the first surface S1, and the elastic sensing pattern layer 222 is formed of a stretchable conductive material and can include one or more sensor units SU and sensing lines SL corresponding to the sensor units SU as shown in FIG. 6. In some embodiments, the elastic sensing pattern layer 222 can be printed on the first surface S1 of the elastic base layer 220 by printing elastic conductive silver paste or graphene to form the sensor units SU in a single region or multiple regions. The first insulating protective layer 224 is disposed on the elastic sensing pattern layer 222, which can be made of ink, for example, and can provide protection and insulation for the elastic sensing pattern layer 222 to improve its durability.

In addition, the elastic conductive layer 226 is disposed on the second surface S2 of the elastic base layer 220 and includes a plurality of conductive lines CL, and the elastic conductive layer 226 can be formed by printing elastic conductive materials such as graphene or conductive silver paste on the second surface S2 of the elastic base layer 220. In addition, the second insulating protective layer 228 can be disposed on a surface of the elastic conductive layer 226 that is not in contact with the elastic base layer 220, and can be made of ink, for example, to provide protection and insulation for the elastic conductive layer 226 to improve its durability.

It should be noted that since the elastic conductive layer 226 is made of high-temperature resistant elastic conductive material, it can not only be used as an electrical shielding layer between the elastic sensing pattern layer 222 and the ground plane, but can also be used as a heating circuit layer. In this way, the capacitive sensing steering wheel 2 not only provides anti-interference capabilities, but also provides the heating function.

It should be noted that in FIG. 6, the sensing circuit layer 22 has an enclosed belt structure similar to the first embodiment, and can be stretched to be larger than the size of the steering wheel grip 20 so as to fit and be sleeved onto the steering wheel grip 20. Finally, the morphology shown in FIG. 6 is formed. For convenience of explanation, FIG. 6 shows the sensing circuit layer 22 in a stretched state, and the first insulating protective layer 224 and the second insulating protective layer 228 are omitted therefrom. Therefore, by utilizing the stretch capability of TPU, the entire sensing circuit layer 22 can have a better covering effect when covering the steering wheel grip 10 without causing wrinkles.

In this embodiment, the elastic conductive layer 226 further includes a plurality of heating lines HL. The processing circuit 24 can be electrically connected to the conductive lines CL of the elastic conductive layer 226 through the heating lines HL, and is configured to generate a plurality of heating signals to drive the conductive lines CL through the heating lines HL to generate thermal energy. It should be noted that a resistance value of each conductive line CL is designed to ensure that the elastic conductive layer 226 can heat the sensing steering wheel 2 to an appropriate temperature range. The heating lines HL serves as a transmission medium for the heating signal, and thus the heating lines has a smaller resistance than the conductive lines CL.

Similar to the first embodiment, when the sensing circuit layer 22 is sleeved onto the steering wheel grip 20, inner and outer edges of the enclosed belt structure of the sensing circuit layer 22 are parallel to an annular surface of the steering wheel grip 20. In more detail, circumferential directions of the inner edge and the outer edge of the enclosed belt structure are parallel to a circumferential direction of the annular surface of the steering wheel grip 20. Similar to the previous embodiments, the inner and outer edges of a portion of the enclosed belt structure are not necessarily parallel to the annular surface of the steering wheel grip 10, but can be adapted to the spokes of the steering wheel grip 10, such that multiple notches can be formed at the inner and outer edges such that the spokes can be avoided when covering the steering wheel rim.

### Third Embodiment

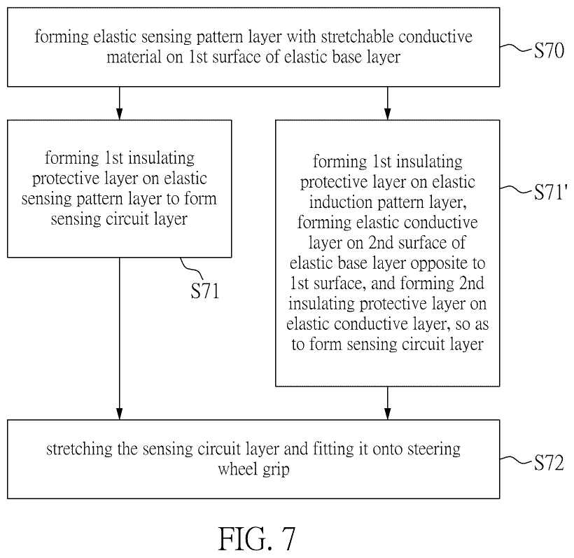

FIG. 7 is a flowchart of a method for fabricating a sensing steering wheel according to a third embodiment of the present disclosure. Referring to FIG. 7, a third embodiment of the present disclosure provides a method for fabricating a sensing steering wheel, and the method at least includes the following steps:

Step S70: forming an elastic sensing pattern layer with a stretchable conductive material on a first surface of an elastic base layer. The elastic sensing pattern layer includes at least one sensing unit and at least one corresponding sensing line.

Step S71: forming a first insulating protective layer on the elastic sensing pattern layer to form a sensing circuit layer. The sensing circuit layer can include an elastic base layer, an elastic sensing pattern layer and a first insulating protective layer as shown in FIG. 3, and have an enclosed belt structure as shown in FIG. 4. In some embodiments, the sensing circuit layer 12 as shown in FIG. 3 can be formed first, the sensing circuit layer 12 is a laminated structure with two open ends, and then the sensing circuit layer 12 forms the enclosed belt structure by connecting the two ends. For example, considering the materials of each layer in the sensing circuit layer 12, welding (for example, an ultrasonic welding machine) can be used to connect the two ends to form the enclosed belt structure.

Optionally, after step S70, step S71′ can be performed instead of step S71.

Step S71′: forming a first insulating protective layer on the elastic induction pattern layer, forming an elastic conductive layer on a second surface of the elastic base layer opposite to the first surface, and forming a second insulating protective layer on the elastic conductive layer, so as to form the sensing circuit layer. The sensing circuit layer can include the elastic base layer, the elastic sensing pattern layer, the first insulating protective layer, the elastic conductive layer and the second insulating protective layer as shown in FIG. 5, and has the enclosed belt structure as shown in FIG. 6.

After step S71 or S71′, the method proceeds to step S72: stretching the sensing circuit layer and fitting it onto the steering wheel grip.

In some embodiments, the method for fabricating the sensing steering wheel can optionally include one or more of the following steps, for example, a step of electrically connecting the processing circuit to the sensing lines, arranging a heating layer between the steering wheel grip and the sensing circuit layer, a step of forming the elastic conductive layer on the elastic base layer, a step of forming the second insulating protective layer on the elastic conductive layer, and a step of electrically connecting the processing circuit to the elastic conductive layer or the heating layer. However, the above steps and implementations have already been described in detail in the first embodiment and the second embodiment, and will not be reiterated herein. Steps of stretching the sensing circuit layer and fitting it onto the steering wheel grip will be described in detail hereinafter.

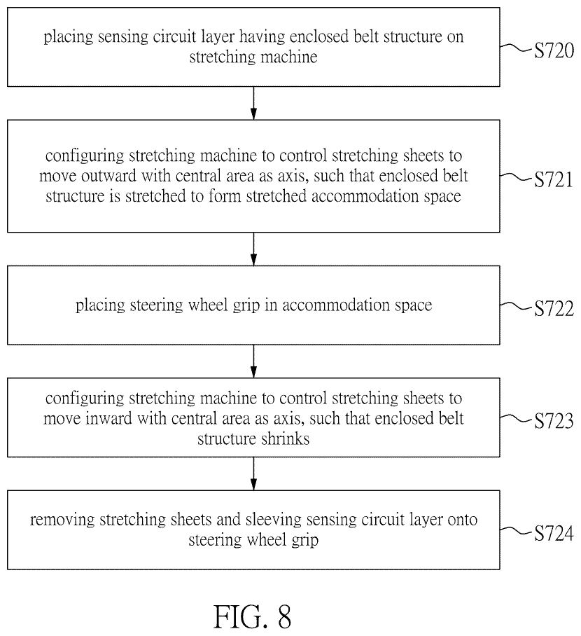

Referring to FIG. 8, FIG. 8 is a detailed flowchart of step S72.

As shown in FIG. 8, step S72 further includes the following steps:

Step S720: placing the sensing circuit layer having the enclosed belt structure on a stretching machine.

Step S721: configuring the stretching machine to control stretching sheets to move outward with a central area as an axis, such that the enclosed belt structure is stretched to form a stretched accommodation space.

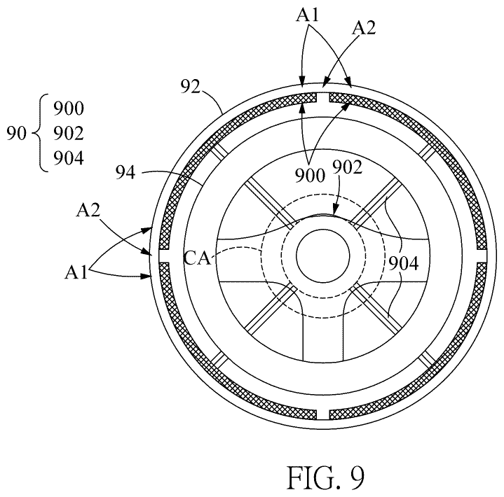

Reference is made to FIG. 9, which is a schematic diagram showing processes of steps S721 and S722 of the present disclosure.

As shown in FIG. 9, the stretching machine 90 has a plurality of stretching sheets 900 arranged around a central area CA. The stretching machine 90 also includes a power mechanism 902 and a plurality of telescopic rods 904 connected to the power mechanism 902. Each of the stretching sheets 900 is connected to the power mechanism 902 through the corresponding telescopic rod 904. The power mechanism 902 can, for example, include a plurality of linear motors respectively connected to the telescopic rods 904 and configured to drive the telescopic rods 904 to control the stretching sheets 900 to move inward or outward with the central area CA as the axis. In actual operation, the power mechanism 902 can first control the stretching sheets 900 to be adjusted to a predetermined size, which is close to (possibly slightly larger than) an initial size of the enclosed belt structure of the sensing circuit layer 92, such that the sensing circuit layer 92 can be sleeved onto the stretching sheets 900. Next, the power mechanism 902 can control the stretching sheets 900 to move outward to stretch the sensing circuit layer 92 to form the accommodating space in the center that the steering wheel grip 94 can enter.

In addition, since the stretching machine 90 can include multiple stretching sheets 900 (four sheets as shown in FIG. 9) arranged around the central area CA, when stretching the sensing circuit layer 92, uniform tension in each area can be ensured, which can avoid excessive stretching of a particular area of the sensing circuit layer 92 causing the printed material therein to break. It should be noted that an initial diameter of the enclosed belt structure needs to be designed to be smaller than an outer diameter of a section of the steering wheel rim (assumed to be circular) of the steering wheel grip 94, such that the sensing circuit layer 92 can be naturally sleeved onto the steering wheel grip 94 when returning from the stretched state.

In some embodiments, the enclosed belt structure of the sensing circuit layer 92 has a plurality of sleeving areas A1 corresponding to the stretching sheets 900 and a plurality of non-sleeving areas A2 that do not correspond to the stretching sheets 900, and a thickness of the enclosed belt structure at the sleeving areas A1 is greater than a thickness at the non-sleeving areas A2, so as to provide greater durability when being stretched by the stretch sheets 900 and prevent the sensing circuit layer 92 from being damaged due to pulling.

Step S722: placing the steering wheel grip in the accommodation space.

Step S723: configuring the stretching machine to control the stretching sheets to move inward with the central area as the axis, such that the enclosed belt structure shrinks.

As shown in FIG. 9, the steering wheel grip 94 can be disposed in the accommodation space formed by stretching the sensing circuit layer 92. Preferably, the stretching machine 90 can be provided with a platform for coaxially aligning the steering wheel grip 94 and the sensing circuit layer 92, but the platform does not interfere with the operation of the power mechanism 902 and the telescopic rods 904. Therefore, the steering wheel grip 94 that has been pre-coated with adhesive on a part of its surface (such as the steering wheel rim) can be placed on the platform after the sensing circuit layer 92 is stretched. In addition to setting the steering wheel grip 94 at an appropriate height, a step of aligning the steering wheel grip 94 with the sensing circuit layer 92 can also be completed.

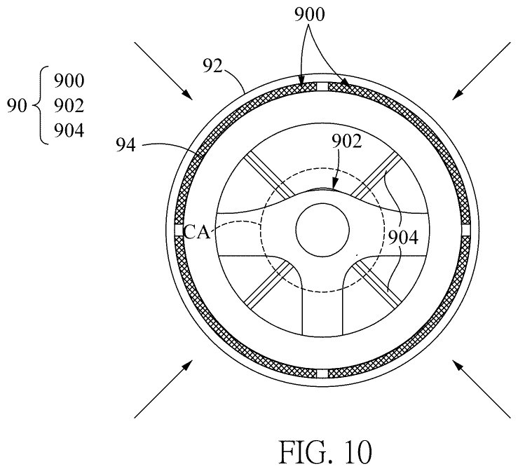

Reference is made to FIG. 10, which is a schematic diagram showing a process of step S723 of the present disclosure. As shown in FIG. 10, after the steering wheel grip 94 is set, the power mechanism 902 can be configured to drive the telescopic rods 904 to control the stretching sheets 900 to move inward with the central area CA as the axis until the stretching sheets 900 is close to an outer edge of the steering wheel grip 94, thereby leaving space for the stretch sheets 900 to exit.

Step S724: removing the stretching sheets and sleeving the sensing circuit layer 92 onto the steering wheel grip.

In this step, the power mechanism 902 not only allows the stretching piece 900 to move inward or outward with the central area CA as the axis, but also allows the stretching sheets 900 to move along a direction along the axis. That is, a direction in which the stretch sheets 900 move out can be perpendicular to a plane formed by the steering wheel rim of the steering wheel grip 94.

In this case, the stretching machine 90 can control the stretching sheets 900 to slowly shrink inward, while releasing the pulling force at an appropriate speed, and allow the stretching sheets 900 to retract under the steering wheel grip 94 while slowly moving out of the sensing circuit layer 92, such that the sensing circuit layer 92 can be bonded to the steering wheel grip 94. However, the above example is only one of the possible embodiments and is not intended to limit the method of stretching the sensing circuit layer of the present disclosure. In a specific embodiment, the sensing circuit layer can also be manually stretched and placed on the steering wheel grip.

Therefore, by utilizing the stretching capability of TPU, the entire sensing circuit layer 92 can have a better covering effect when covering the steering wheel grip 94 without causing wrinkles, and finally the sensing steering wheel 1 is presented as shown in FIG. 1.

### Beneficial Effects of the Embodiments

In conclusion, in the sensing steering wheel and the method for fabricating the same provided by the present disclosure, the elastic sensing pattern layer such as elastic conductive silver paste or graphene can be printed on the elastic base layer. By utilizing the stretching capability of the elastic base layer, the entire sensing circuit layer is capable of having a better covering effect when covering the steering wheel grip without causing wrinkles, which can reduce the complexity of assembly and production and manufacturing costs.

Furthermore, in the sensing steering wheel and the method for fabricating the same provided by the present disclosure, an elastic conductive layer is further provided on another side of the elastic base layer. By using a high temperature resistant elastic conductive material, it can not only be used as an electrical shielding layer, but also can be used as a heating circuit layer at the same time. In addition to providing the anti-interference ability of the capacitive sensing steering wheel, it can also provide a heating function for the sensing steering wheel, which can greatly speed up the production process and reduce costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A sensing steering wheel, comprising:
a steering wheel grip; and
a sensing circuit layer, including:
an elastic base layer having a first surface and a second surface opposite to each other;
an elastic sensing pattern layer disposed on the first surface, wherein the elastic sensing pattern layer is formed of a stretchable conductive material and includes at least one sensor unit and at least one sensing line corresponding to the at least one sensor unit; and
a first insulating protective layer disposed on the elastic sensing pattern layer;
wherein the sensing circuit layer has an enclosed belt structure and is stretched to sleeve onto the steering wheel grip.

2. The sensing steering wheel according to claim 1, wherein the at least one sensor unit generates at least one sensing signal in response to being touched by an object.

3. The sensing steering wheel according to claim 2, further comprising:
a processing circuit electrically connected to the at least one sensing wire, wherein the processing circuit is configured to determine a holding state of the steering wheel grip according to the at least one sensing signal.

4. The sensing steering wheel according to claim 3, further comprising:
a heating layer disposed between the steering wheel grip and the sensing circuit layer, wherein the heating layer includes a plurality of first heating lines.

5. The sensing steering wheel according to claim 4, wherein the processing circuit is further electrically connected to the heating layer and is configured to generate a plurality of first heating signals to drive the first heating lines for heating.

6. The sensing steering wheel according to claim 3, wherein the sensing circuit layer further includes:
an elastic conductive layer disposed on the second surface of the elastic base layer and includes a plurality of conductive lines; and
a second insulating protective layer disposed on the elastic conductive layer.

7. The sensing steering wheel according to claim 6, wherein the elastic conductive layer further includes a plurality of second heating lines, the processing circuit is electrically connected to the elastic conductive layer and is configured to generate a plurality of second heating signals to drive the plurality of second heating lines to produce thermal energy.

8. The sensing steering wheel according to claim 1, wherein an inner edge and an outer edge of the enclosed belt structure are parallel to the steering wheel grip.

9. A method for fabricating a sensing steering wheel, the method comprising processes of:
forming an elastic sensing pattern layer with a stretchable conductive material on a first surface of an elastic base layer, wherein the elastic sensing pattern layer includes at least one sensing line;
forming a first insulating protective layer on the elastic sensing pattern layer, so as to form a sensing circuit layer including the elastic base layer, the elastic sensing pattern layer and the first insulating protective layer, wherein the sensing circuit layer has an enclosed belt structure; and
stretching the sensing circuit layer and sleeving the sensing circuit onto a steering wheel grip.

10. The method according to claim 9, wherein the elastic sensing pattern layer further includes at least one sensor unit corresponding to the at least one sensing line, and the at least one sensor unit generates at least one sensing signal in response to being touched by an object.

11. The method according to claim 10, further comprising:
electrically connecting a processing circuit to the at least one sensing line, wherein the processing circuit is configured to determine a holding state of the steering wheel grip according to the at least one sensing signal.

12. The method according to claim 11, further comprising:
disposing a heating layer on the steering wheel grip before stretching the sensing circuit layer and sleeving the sensing circuit layer onto the steering wheel grip, wherein the heating layer includes a plurality of first heating lines.

13. The method according to claim 12, further comprising:
electrically connecting the processing circuit to the heating layer, wherein the processing circuit is configured to generate a plurality of first heating signals to drive the plurality of first heating lines for heating.

14. The method according to claim 11, further comprising:
forming an elastic conductive layer on a second surface of the elastic base layer opposite to the first surface, wherein the elastic conductive layer includes a plurality of conductive lines; and
forming a second insulating protective layer on the elastic conductive layer.

15. The method according to claim 14, further comprising:
electrically connecting the processing circuit to the elastic conductive layer;
wherein the elastic conductive layer further includes a plurality of second heating lines, and the processing circuit is configured to generate a plurality of second heating signals to drive the plurality of second heating lines to produce thermal energy.

16. The method according to claim 9, wherein the processes of stretching the sensing circuit layer and sleeving the sensing circuit layer onto the steering wheel grip further includes:
placing the sensing circuit layer having the enclosed belt structure on a stretching machine, wherein the stretching machine has a plurality of stretching sheets arranged around a central area, and the sensing circuit layer is placed on and sleeved on the plurality of stretching sheets;
configuring the stretching machine to control the plurality of stretching sheets to move outward with the central area as an axis, such that the enclosed belt structure is stretched to form an accommodation space;
placing the steering wheel handle in the accommodation space;
configuring the stretching machine to control the stretching sheets to move inward with the central area as the axis, such that the enclosed belt structure shrinks; and
removing the plurality of stretching sheets and sleeving the sensing circuit layer onto the steering wheel grip.

17. The method according to claim 16, wherein the stretching machine further includes a power mechanism and a plurality of telescopic rods connected to the power mechanism, the plurality of telescopic rods are connected to the stretching sheets, respectively, and the power mechanism is configured to drive the plurality telescopic rods to control the plurality of stretching sheets to move inward or outward with the central area as the axis.

18. The method according to claim 16, wherein the steering wheel grip is annular, and a quantity of the stretching sheets is at least four.

19. The method according to claim 18, wherein the enclosed belt structure of the sensing circuit layer has a plurality of sleeving areas corresponding to the stretching sheets and a plurality of non-sleeving areas not corresponding to the stretching sheets, and a thickness of the enclosed belt structure at the sleeving areas is greater than a thickness at the non-sleeving areas.

20. The method according to claim 9, wherein an inner edge and an outer edge of the enclosed belt structure are parallel to the steering wheel grip.
